(19) United States
(12) Patent Application Publication
(10) Pub. No.: US 2007/0183074 A1
(43) Pub. Date: Aug. 9, 2007

(54) Disk drive defect map encoding scheme

(75) Inventor: Paul Henry Chandler Smith, Salt Lake City, UT (US)

Correspondence Address: Powell and Associates, P.O. Box 1679, American Fork, UT, 84003, US

(73) Assignee: FUJIFILM Microdisks USA Inc.

(21) Appl. No.: 11/286,993

(22) Filed: Nov. 23, 2005

(51) Int. Cl. G11B 5/09

(52) U.S. Cl. 360/53

(57) ABSTRACT

A method for encoding defect locations on a storage medium into compact defect map is described. The method comprises creating a first list which defines a sequence of retrievable portions and non-retrievable portions of the disk or storage medium, compressing this first list of retrievable/non-retrievable portions into a second list of encoded sequences, and then storing the second list of encoded sequences for future retrieval.

### BACKGROUND OF THE INVENTION

This invention relates to the field of disk drive systems, and in particular, to a method of encoding a defect map in a disk drive.

Disk drives are commonly used in personal computers, laptops, portable drive devices and other electronic/computer systems to store large amounts of data in a form that can be made readily available to the user. In general, the disk drive includes a magnetic disk that is rotated by a spindle motor. The surface of the disk is divided into a series of data tracks. The data tracks are spaced radially from one another across a band having an inner diameter and an outer diameter. Each of the data tracks generally extends circumferentially around the disk and can store data in the form of magnetic transitions within the radial extent of the track on the disk surface. Typically, each data track is divided into a number of data sectors that can store fixed sized data blocks.

Disk drives are often enclosed in order to protect the disk's surface from defects that may be caused from physical contact with outside objects. Because removable disk drives do not have a sealed structure, the disk surface is exposed to environmental objects and contamination. In the case that the magnetic medium comes in contact with foreign objects, scratches and other forms or defects may occur on the surface of the disk. When defects occur due to fabrication, use, or physical contact, some sectors of a damaged disk often become incapable of being read/written by the disk drive. The positional information of these bad sectors is generated and maintained in a list which is commonly referred to as a defect map or defect list. During normal operation a disk drive will reference the defect map in order to avoid reading/writing data from/to the damaged sectors of the disk.

In some conventional enclosed disk drive systems, such as in a personal computer hard drive system which incur fewer defects through normal use than do removable drive systems, a simple approach may be used in order to manage the defect map. Conventional methods have registered any track containing defective sectors as unusable. However, the problem of such a method is that it can dramatically decrease the available disk space in disk drives having large defect densities. In order to avoid this problem, some disk drives store a complete map of all the bad sectors on every track. However, the problem of this method is that for maps representing disk drives of large capacities and large defect densities, the map structure can become very large (as described subsequently with FIG. 1). Hence, there is a need in the art for a compact map representation.

### SUMMARY OF THE INVENTION

In accordance with the preferred method of the present invention, a defect map encoding method includes: Representing the defect map as a sequence of run-lengths (count of consecutive sectors) of alternate good/bad sectors, indicating whether the first run is a good or bad run, and compressing the sequence using a defined-word compressor. The defined-word compressor has the capacity to determine an optimum mapping between run-lengths and codewords used to represent each run-length based on the statistical probability of encountering each run-length in the map.

All objects, features, and advantages of the present invention will become apparent in the following detailed written description.

### BRIEF DESCRIPTION OF THE DRAWINGS

FIG. 1 is a table representing defect map sizes resulting from various techniques used to represent the same sequence of defects on a disk.

FIG. 2 shows a recording disk of a disk drive system within a computer system of FIG. 5;

FIG. 3 shows two common types of defects on a recording disc.

FIG. 4 is a high level logic flow diagram of a method for formatting a disk, including the steps performed to generate a defect map according to the present invention;

FIG. 5 is a block diagram of a computer system in accordance with the present invention;

FIG. 6A shows an example of defective sectors on several consecutive tracks on a recording disk;

FIG. 6B to 6D are explanatory diagrams each showing the steps taken by a Huffman compressor (a type of defined-word compressor), using an ensemble generated from the defective sectors of FIG. 6A;

### DETAILED DESCRIPTION OF THE INVENTION

In order to develop a method which most effectively fills the need in the art, the inventor of the present invention developed and reduced to practice 5 distinct and novel solutions. Each of these will be described in detail below.

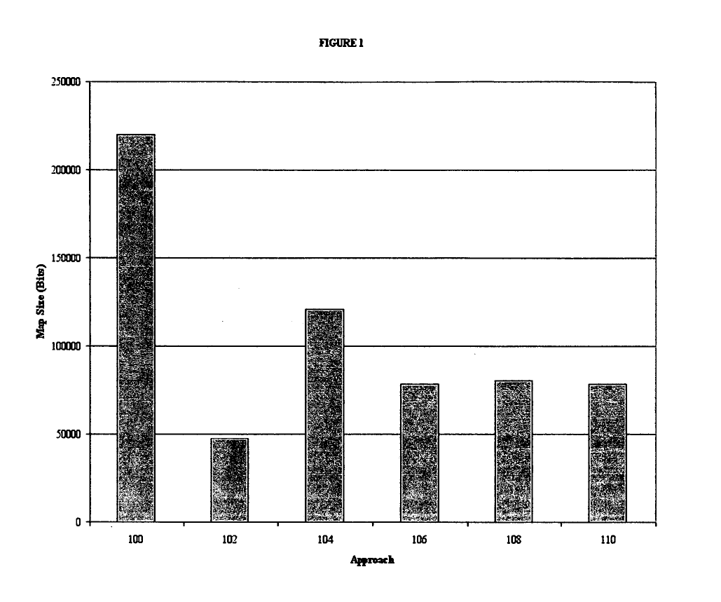

A first embodiment developed and reduced to practice comprises: Representing the defect map as a bit field of good and bad sectors; indicating a good block with a 1 and representing a bad block with a 0; compressing this bit field with a dictionary based compressor (such as an LZ77 variant); and further compressing the dictionary-based compressed sequence using a defined-word compressor (such as a Huffman, Shannon-Fano or Algebraic compressor). This embodiment results in a highly compact map, but decoding the defect map takes significant time due to the series combination of the two compressors. While other methods had an O(n)=n time, which means that the time required to decompress the defect map increased linearly with the size of the defect map, this embodiment had a O(n)=nˆ2 time. This means the time required to decompress the defect map increased exponentially with the size of the defect map. The results of this first embodiment are represented as 102 in FIG. 1. Obvious where time is not a significant factor this first embodiment works well to create a highly compact map.

A second embodiment developed and reduced comprises converting the defect map into a sequence of run-lengths of alternating good/bad regions of the disk. To reduce the number of distinct codewords in the map, each run-length was converted to a decreasing sequence of power-of-2 numbers. A new run-length is be determined either by a change in the direction of the numbers, or by a value of 0 inserted between sequences. For example, consider the following sequence of run lengths:
65 1 64 2 1 192 5
The resulting uncompressed defect map would be:
641 1 640 20 1 128640 41
This uncompressed defect map is then passed through a defined-word compressor to generate a final defect map. This second embodiment produces a very compact codebook or translation table (a table that defines the mapping between codewords and their corresponding run-lengths), but the resulting compressed defect map is relatively large (as represented by 104 in FIG.1).

A third embodiment developed and reduced to practice comprises converting the defect map into a sorted list of starting bad blocks and lengths (excluding good blocks from the list) and passing this list through a defined-word compressor. This third embodiment results in an efficiently compressed map. This embodiment requires a large translation table. The results of the third embodiment are represented as 106 in FIG. 1.

A fourth embodiment developed comprises converting the defect map to a sorted list of tracks, sectors and defect lengths and passing this sorted list through a defined-word compressor. Similar to the third embodiment, this fourth embodiment resultes in a compact map structure and also requires a large translation table. The results of the fourth embodiment are represented as 108 in FIG.1.

A fifth embodiment developed comprises: Representing the defect map as a sequence of run-lengths of alternate good/bad sectors; indicating whether the first run represents a count of good or bad sectors; and compressing the sequence using a defined-word compressor. This embodiment results in a highly compact defect map with a relatively small translation table (as represented by 110 in FIG. 1). The simplistic nature of this fifth embodiment combined with the speed with which it can be decompressed adds further benefits to its implementation and use. This fifth embodiment is further described below.

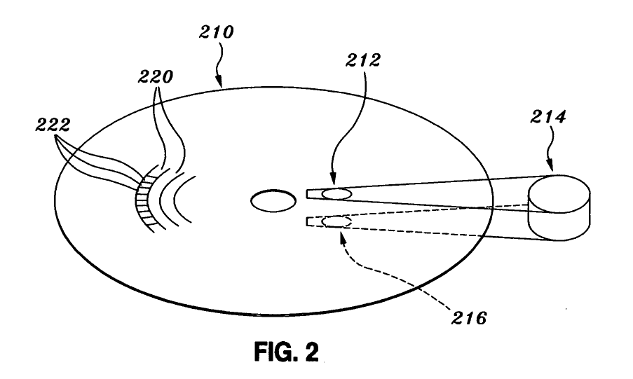

According to the fifth embodiment and as shown in FIG. 2, head assembly 214 controls the magnetic heads 212 and 216 for reading and writing from and/or to both the top side and the bottom side of the recording disk 210. Data is stored in concentric tracks 220 in circumferentially divided sectors 222.

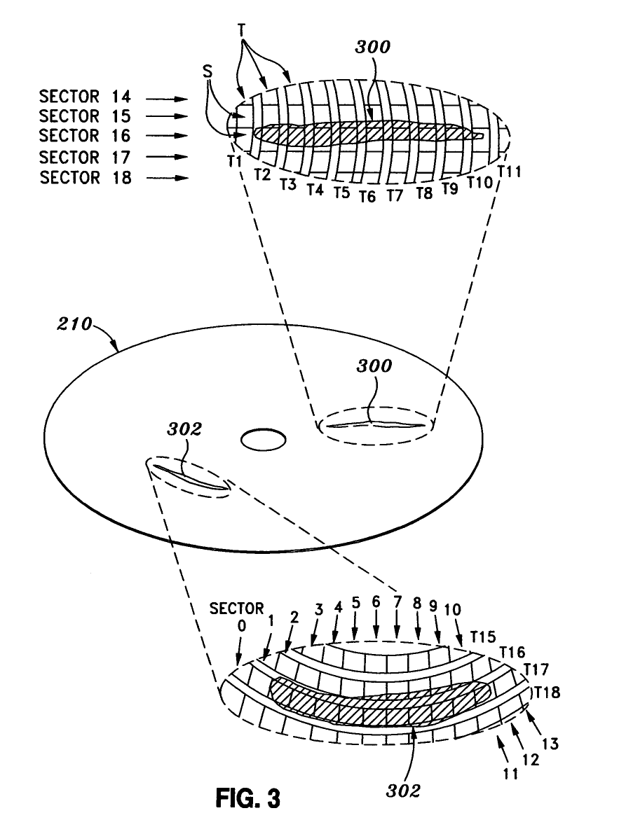

FIG. 3 shows an example of a radial scratch 300 and a circumferential scratch 302 on the surface of recording disk 301. As can be seen, radial scratch 300 damages sectors 15 and 16 on tracks T2-T9 with each track containing 100 sectors total per track. Radial scratch 300 also damages sector 16 on track T10. In the corresponding section of the defect map, the uncompressed run-lengths would be:
. . . 2 98 2 98 2 98 2 98 2 98 2 98 2 98 2 98 1
In this manner radial scratches, such as 300, will tend to produce long alternating sequences of run-lengths of equal length. Because radial scratches tend to create long repeating sequences of run-lengths, each run-length will occur more often in the defect map and will be assigned a shorter codeword by the defined-word compressor. Thus, while a radial scratch will result in a large number of runs of good/bad sectors, each run-length will be represented by a smaller codeword than other less frequent run-lengths creating a compact representation of the radial scratch in the defect map.

Circumferential scratch 302 causes damage to sectors 2-11 in track T17 (10 bad sectors) and sectors 6-10 in track T16 (5 bad sectors) where each track has 100 total sectors. In the corresponding section of the defect map, the uncompressed run-lengths would be (there being 92 good sectors between the scratch on T16 and that on T17):
. . . 5 92 10
In this manner circumferential scratches, such as 302, will tend to produce a short sequence of run-lengths. In this case the compressor will assign longer codewords to these run-lengths in comparison to the codewords assigned to the run-lengths occurring more often. However, because each run-length occurs only a small number of times, the space taken up in the defect map is small.

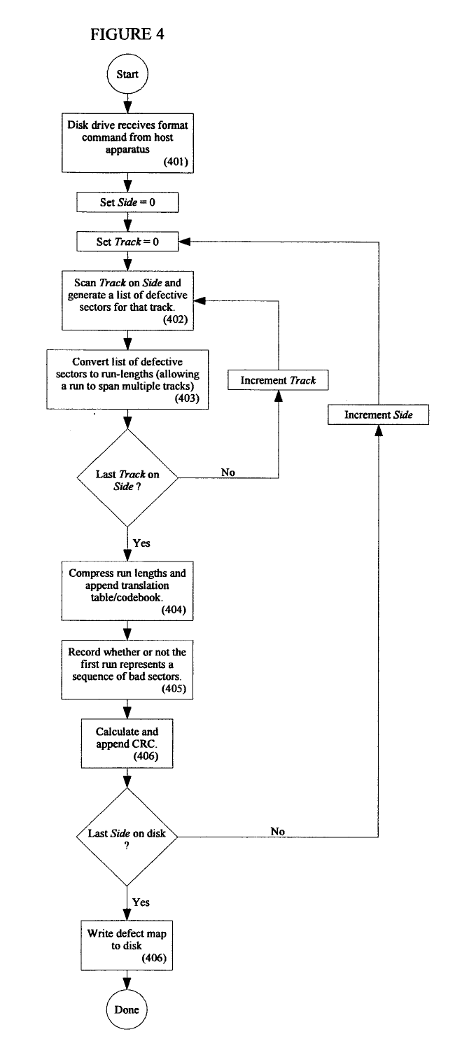

Referring now to FIG. 4, there is depicted a logical flow diagram of the method of formatting a disk drive, including the steps required to generate a defect map according to the preferred embodiment. As shown, the disk drive receives a format command from the host apparatus 401. This command informs the disk drive to iterate for each side of the disk, traversing sequentially by track across the disk surface. For each track, the disk drive scans the track and generates a first list of every bad sector on every track, 402. The code then converts this first list into a second list of run-lengths, 403. When the format is completed (either on a given side, or for the entire disk), the second list of run-length is compressed using a defined-word compressor such as, but not limited to, a Huffnan compressor, Shannon-Fano compressor or Algebraic compressor to generate a third, bit-packed list of codewords 404. The disk drive will also append a codebook or translation table to the third packed list of codewords that may be used to convert the codewords back into their respective run-lengths. The disk drive also records whether the first run-length in the defect map represents a sequence of good or bad sectors 405. Lastly, upon completing the compression of the defect map, a cyclic redundancy code (CRC) is calculated and appended to the defect map, 406. The CRC code is calculated based on various characteristics of the compressed sequence and is used to check for errors when the defect map is read from the removable disk. Once the CRC is appended to the defect map sequence, the combined sequence is stored on recordable disk 407 and the disk drive waits for the next command from the host apparatus 408.

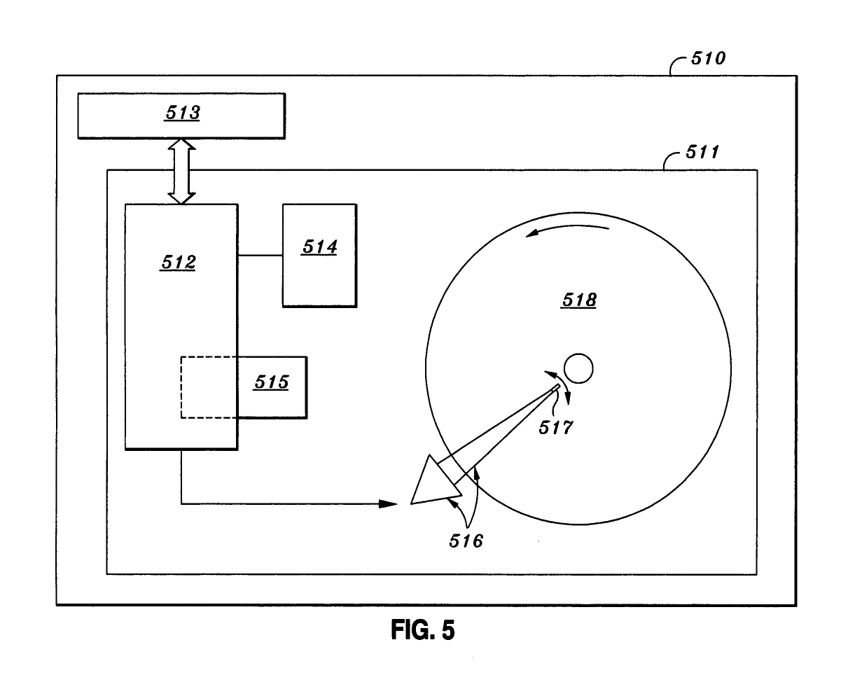

FIG. 5 is a block diagram of a computer system 510. As shown, computer system 510 includes a disk drive 511 and a host apparatus 513 that instructs disk drive 511 to perform the reading and writing functions. Disk drive 511 may be built into the host apparatus 513 or be external to host apparatus 513. Disk drive 511 may house at least one recording disks 518 which may be one or two-sided. Recording disk 518 is read from or written to with magnetic heads 517, which are controlled by a head assembly 516 and controller 512. The controller includes a compressor 515 implemented either as software or as a distinct piece of hardware. The controller 512 controls the operation of the head assembly 516, the magnetic head 517, the compressor 515, and memory 514.

Recording disk 518 is a non-volatile recording medium such as a magnetic disk or equivalent. Recording disk 518 is driven rotationally by a motor (not shown) at a predefined speed. Multiple tracks are concentrically formed on recording disk 518 (see tracks T in FIG. 2) as blocks for storing data and each track is divided circumferentially into multiple sectors (see sectors S in FIG. 2). Controller 512 is provided with a memory 514 and a defined-word compressor 515 implemented either as a software algorithm within the controller or as a separate piece of hardware.

With reference now to FIG. 4 & 5, controller 512 receives a format command (401) from the host apparatus 513. Controller 512 scans both sides of the removable disk 518 generating a list of bad sectors for each track (402). The controller 512 performs this scan by moving head assembly 516 which moves the magnetic head 517 over the surface of recording disk 518. Controller 512 then converts the list of bad sectors for each track into a sequence of alternating run-lengths of good/bad sectors (403) and stores the run-lengths in memory 514. Controller 512 then processes the run-length sequence through a defined-word compressor 515 (step 405). The compressor 515 also appends a translation table to the beginning of the compressed run-length sequence. The translation table is used by the controller 512 to later translate the codewords created by compressor 515 into a sequence of run-lengths. Once compressed, the controller 512 calculates and appends a standard cyclic redundancy code or CRC (406) to the defect map. Once all tracks on both sides of the removable disk are scanned, controller 512, controlling the magnetic head 517 through the head apparatus 516, writes the defect map (407) back onto the recording disk 518. The controller 512, then waits for further commands from the host apparatus (408).

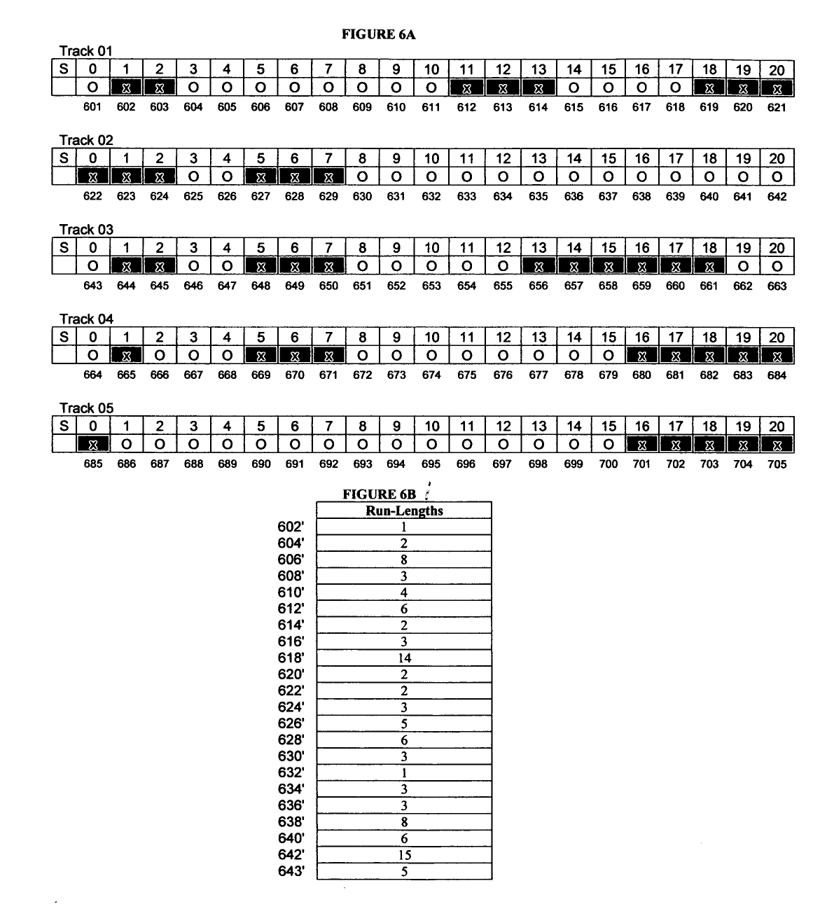

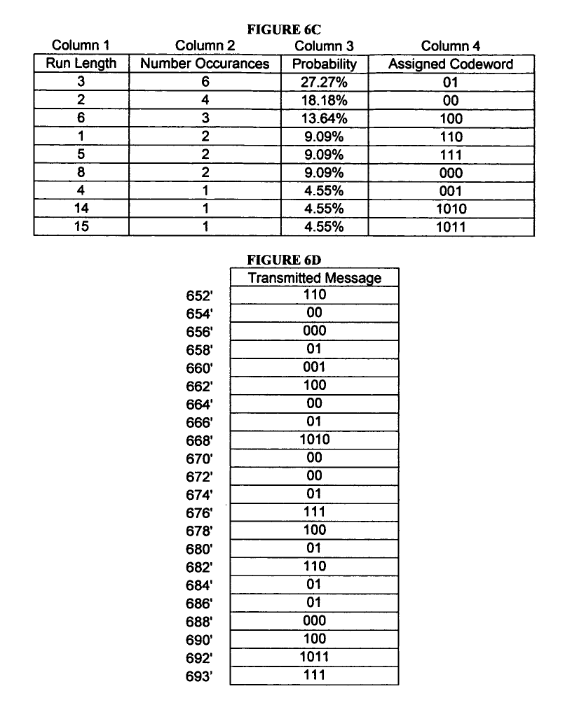

FIG. 6A shows 5 sample tracks with 21 sectors per track that will be represented in a defect map using the preferred embodiment. An “O”, as in sector 0 (601), represents sectors that are good or non-defective. An “x”, as in sectors 1 (602) and 2 (603), represent sectors that are bad or defective. Hence, sectors 1 (602) and 2 (603) comprise a run of 2 bad sectors.

FIG. 6B shows the run-length sequence (also called the ensemble) that would be generated in step 403 in FIG. 4 from the tracks shown in FIG. 6A.

FIG.6C shows the number of times each run-length occurs in FIG. 6B (column 2), the statistical probability of occurrence of each run-length in FIG. 6.A (column 3) as well as the codeword assignments (column 4), made by a defined-word compressor (specifically a Huffman compressor).

FIG. 6D shows the final compressed defect map that would be stored on the recording disk. As represented in the table, the defect map for FIG. 6A would be represented by the bit sequence: 110 00 000 01 001 100 00 01 1010 00 00 01 111 100 01 110 01 01 000 100 1011 111. Note that this 58 bit long sequence fully describes the 105 sectors represented on the 5 tracks.

Although the description of the present invention has utilized various embodiments, it will be recognized that the present invention is not limited to the specific embodiments described. Rather, the present invention encompasses all variants incorporating the essence of the ideas presented in the above description.

What is claimed is:

1. A method comprising:
creating a first list defining a sequence of retrievable portions and non-retrievable portions of a storage medium;
compressing the first list into a second list defining encoded sequences; and
storing the second list for future retrieval.

2. The method of claim 1 wherein the step of creating a first list comprises creating a defect list wherein the defect list defines portions of the storage medium that are incapable of storing retrievable information.

3. A method according to claim 1 wherein the step of storing the second list for future retrieval comprises appending a translation table to the third list.

4. A method according to claim 1 wherein the step of storing the second list for future retrieval comprises calculation a CRC from the second list.

5. A method according to claim 1 wherein the step of storing the second list for future retrieval further comprises appending the CRC to the second list.

6. A method according to claim 1 wherein the portions are sectors along tracks of the storage medium.

7. A method according to claim 1 wherein the storage medium is part of a disk drive.

8. The method of claim 1 wherein the first list is a run-length sequence.

9. The method of claim 1 wherein the second list is a compressed run-length sequence.

10. A method comprising:
creating a defect list wherein the defect list defines portions of a storage medium that are incapable of storing retrievable information;
converting the defect list to a second list defining at least a sequence of non-retrievable portions;
compressing the second list into a third list defining encoded sequences; and
storing the third list for future retrieval.

11. A method according to claim 10 wherein the step of storing the third list for future retrieval comprises appending a translation table to the third list.

12. A method according to claim 10 wherein the step of storing the third list for future retrieval comprises calculation a CRC from the third list.

13. A method according to claim 10 wherein the step of storing the third list for future retrieval further comprises appending the CRC to the third list.

14. A method according to claim 10 wherein the portions are sectors along tracks of the storage medium.

15. A method according to claim 10 wherein the storage medium is part of a disk drive.

16. The method of claim 10 wherein the second list is a compressed run-length sequence.

17. The method of claim 10 wherein the third list is a compressed version of the second list.

18. A system comprising:
a media storage unit, the media storage unit storing retrievable information that can be received from the system and retrievable information that can be transmitted to the system;
wherein the media storage unit comprises:
a storage medium;
a processor creating a defect map defining portions of the storage medium that are incapable of storing retrievable information, the processor engaging the storage medium to retrieve and transmit information;
a converter, the converter changing the defect map into a sequence of at least non-retrievable portions of the storage medium; and
a compressor coupled to the converter wherein the converter inputs the sequence of retrievable portions to the compressor and the compressor outputs an encoded sequence that is stored on the storage medium for future retrieval.
